(19) United States
(12) Patent Application Publication
(10) Pub. No.: US 2007/0134144 A1
(43) Pub. Date: Jun. 14, 2007

(54) Gold- and reducible oxide-based composition, method for the preparation and the use thereof in the form of a catalyst, in particular for carbon monoxide oxidation

(76) Inventors: Franck Fajardie, Rueil-Malmaison (FR); Stephan Verdier, Rueil-Malmaison (FR); Kazuhiko Yokota, Paris (FR)

Correspondence Address: Jean-Louis Seugnet;Rhodia Inc-Legal Department, 8 Cedar Brook Drive, CN 7500, Cranbury, NJ, 08512-7500, US

(21) Appl. No.: 10/588,641

(22) PCT Filed: Feb. 17, 2005
(86) PCT No.: PCT/FR05/00377

§ 371 Date: Aug. 4, 2006

(30) Foreign Application Priority Data
Feb. 18, 2004 (FR) 0401614

(51) Int. Cl. B01J 27/128; B01J 27/135

(52) U.S. Cl. 423/210; 502/227; 502/229

(57) ABSTRACT

The invention relates to a gold-based composition on a reducible oxide-based support characterised in that the halogen content thereof with respect to a molar halogen/gold ratio is equal to or less than 0.05, wherein the gold is embodied in the form of particles whose size is equal to or less than 10 nm and the composition is exposed to reduction treatment. The inventive composition can be used in the form of a catalyst in carbon monoxide oxidation methods, for treating tobacco smoke and air.

The present invention relates to a composition based on gold and a reducible oxide, its method of preparation and its use as catalyst, particularly for oxidizing carbon monoxide.

Gold-based catalysts already exist, used in particular in CO oxidation methods. Moreover, a number of these oxidation methods take place at relatively low temperatures, for example lower than 250° C., particularly in water gas shift reactions. Attempts have even been made to oxidize CO at ambient temperature, for example in air treatment processes, and/or under difficult conditions such as very high hourly space velocities (HSV), as is the case for example of the treatment of tobacco smoke.

The catalysts available today and usable from an economic standpoint do not offer sufficient performance to meet this need.

It is the object of the invention to provide effective catalysts at low temperatures and/or high HSV.

For this purpose, the composition of the invention is based on gold, on a support based on at least one reducible oxide, and is characterized in that its halogen content expressed by the halogen/gold molar ratio is equal to or lower than 0.05, in that the gold is present in the form of particles equal to or lower than 10 nm in size, and in that it has undergone a reducing treatment, to the exclusion of compositions with supports in which the only reducible oxide or oxides is/are cerium oxide, cerium oxide in combination with zirconium oxide, cerium oxide in combination with praseodymium oxide, cerium oxide in combination with titanium dioxide or stannous oxide in a Ti/Ce or Sn/Ce atomic proportion lower than 50%.

The invention also relates to the method for preparing this composition which, in a first embodiment, is characterized in that it comprises the following steps:
a compound based on at least one reducible oxide is contacted with a gold-halide-based compound, forming a suspension of these compounds, the pH of the medium thus formed being fixed at a value of at least 8;
the solid is separated from the reaction medium;
the solid is washed with a basic solution;
   the method further comprising a reducing treatment before or after the abovementioned washing step.

The invention also relates to a method according to a second embodiment which is characterized in that it comprises the following steps:
gold is deposited on a compound based on at least one reducible oxide by impregnation or by ion exchange;
the solid issuing from the preceding step is washed with a basic solution having a pH of at least 10;
   the method further comprising a reducing treatment before or after the abovementioned washing step.

The compositions of the invention are effective at low temperatures, high HSV and also with low gold contents.

Other features, details and advantages of the invention will appear even more completely from a reading of the description that follows, and the various concrete but nonlimiting examples provided to illustrate it.

The periodic table of elements referred to in this description is the one published in the Supplement au Bulletin de la Société Chimique de France no 1 (January 1966).

Rare earth means the elements of the group consisting of yttrium and the elements of the periodic table with an atomic number of between 57 and 71 inclusive.

Specific surface area means the BET specific surface area determined by nitrogen adsorption according to standard ASTM D 3663-78 based on the BRUNAUER-EMMETT-TELLER method described in The Journal of the American Chemical Society, 60, 309 (1938).

As stated above, the composition of the invention comprises gold and a reducible oxide. The reducible oxide forms a support.

The term “support” must be understood in a broad sense to designate, in the composition of the invention, the majority component or components in the composition, the supported element essentially being present at the surface of these components. For simplification, we shall speak in the rest of the description of a support and a supported phase, but it should be understood that we would not extend beyond the scope of the present invention in the case in which an element described as belonging to the supported phase were present in the support, for example by having been introduced therein during the actual preparation of the support.

Reducible oxide means an oxide of a metal which may have several degrees of oxidation.

It should be observed that the metal used in the composition of the support is present in a form that consists essentially or exclusively of the oxide of said metal. “Consists essentially” means here that amorphous species of the hydroxide or oxyhydroxide type, for example, are only present in traces.

By defining as amorphous any product of which the XR diffractogram does not display diffraction lines centered on the oxide phase or of which the XR diffractogram displays halos centered on the oxide phase but of which the width at mid-height would serve to calculate crystallite sizes lower than 2 nm by the Debye-Scherrer method, it must be understood, in the context of the present invention, by the expression: “amorphous species are only present in traces”, that the comparison of an XR diagram of a pure metal oxide with that of an oxide of the same metal but containing these species does not reveal any detectable differences and particularly does not reveal halos.

As reducible oxides suitable in the context of the present invention, mention can be made of the oxides of transition metals and the rare earth oxides. Transition metals mean the elements of groups IIIA and IIB of the periodic table.

Mention can be made more particularly of titanium, manganese, iron, copper, cobalt and tin oxides. Hence the support may advantageously be based on at least one of these oxides.

As indicated above, the context of the present invention does not include a number of specific supports. These are supports based on cerium oxide, cerium oxide and zirconium oxide, cerium oxide and praseodymium oxide, cerium oxide in combination with titanium dioxide or stannous oxide in a Ti/Ce or Sn/Ce atomic proportion lower than 50%, insofar as these oxides are the only reducible oxides present in the support. Hence it should be observed that a support based on the above-mentioned oxides but also containing another reducible oxide, for example manganese dioxide, is not excluded from the present invention.

The compound used for the support must also have a sufficiently high specific surface area to permit a dispersion of the gold at its surface such that the gold has a sufficient catalytic activity.

Finally, the composition of the invention must have undergone a reducing treatment. Reducing treatment means a treatment that is carried out under conditions such that the support (reducible oxide) and the supported phase (gold) are both reduced. The fact that the composition has undergone such treatment may be reflected by the presence of an oxygen vacancy in the support, that is, that the quantity of oxygen of the oxide forming the support is lower than the stoichiometric quantity. This oxygen vacancy can, for example, be revealed by X-ray diffraction or by analysis using the XPS technique.

It should be noted that the composition of the invention may contain gold with, in addition, at least one other metal element selected from silver, platinum, palladium and copper. In this case, the other metal element(s) may be present for example in a quantity equal to or less than 400%, more particularly equal to or less than 120% and especially between 5% and 50% compared to the gold, this quantity being expressed as mol % of metal element(s)/gold. The compositions of this type, when used at high HSV, can reach their maximum efficiency even more rapidly.

The gold contents, or contents of gold and above-mentioned metal element, of the composition are not critical, and correspond to the contents generally used in catalysts to obtain catalytic activity. For example, this content is equal to or less than 5%, especially equal to or less than 1%. It may be more particularly equal to or less than 0.5% and even equal to or less than 0.25%. Contents higher than 5% generally have no economic interest. These contents are expressed as a mass percentage of gold, optionally with the metal element, with respect to the oxide (or oxides) making up the support.

The composition of the invention has two other specific features.

The first is its halogen content. The halogen may be more particularly bromine or chlorine. This content, which is expressed by the halogen/gold molar ratio, is equal to or less than 0.05. More particularly, it is equal to or less than 0.04 and even more particularly equal to or less than 0.025.

The halogen can be determined by using the following method. The quantity of catalyst necessary for analysis is vaporized in the flame of an oxyhydrogen gas blowpipe (H₂/O₂ mixture at about 2000° C.). The resulting vapor is trapped in an aqueous solution containing hydrogen peroxide. If a solid residue is obtained after the treatment with the oxyhydrogen gas blowpipe, it is placed in suspension in the solution in which the combustion gases (water+H₂O₂) have been collected, and is then filtered. The filtrate collected is then analyzed by ionic chromatography and the halogen content calculated by incorporating the appropriate dilution factor. The halogen content of the catalyst is finally calculated by taking account of the mass of catalyst used for the analysis.

The other feature is the size of the gold particles present in the composition. These particles have a size equal to or lower than 10 nm. Preferably, it is equal to or lower than 3 nm.

Here, and for the rest of the present description, this size is determined by the analysis of the X-ray spectra of the composition, using the width (w) at mid-height of the gold diffraction peak. The particle size is proportional to the inverse (1/w) of the value of this width w. It may be noted that XR analysis is unsuitable for detecting a phase corresponding to gold for particles lower than 3 nm in size, or for detecting gold for gold contents lower than 0.25%. In these two cases, TEM analysis can be used.

The method for preparing the composition of the invention will now be described.

This method can be carried out according to a first embodiment.

In this first embodiment, the first step of the method consists in contacting a reducible-oxide-based compound with a gold-halide-based compound and, if applicable, with a compound based on platinum, palladium or copper. This contacting is carried out by forming a suspension that is generally an aqueous suspension.

This initial suspension can be obtained from a preliminary dispersion of a reducible-oxide-based support of the type described above, prepared by dispersing this support in a liquid phase, and by mixing with a solution or a dispersion of the gold compound. As a compound of this type, use can be made of the chlorine or bromine compounds of gold, for example, chlorauric acid HAuCl₄ or its salts such as NaAuCl₄ which are the most common compounds.

In the case of the preparation of a composition also comprising silver, platinum, palladium or copper, inorganic acid salts such as nitrates, sulfates or chlorides can be selected as compounds of these elements.

Use can also be made of organic acid salts and particularly salts of saturated aliphatic carboxylic acids or salts of hydroxycarboxylic acids. As examples, mention can be made of formates, acetates, propionates, oxalates or citrates. Finally, for platinum, mention can in particular be made of tetrammine platinum(II) hydroxide.

For the rest of the description of the method, only the gold-halide-based compound will be mentioned, but it should be understood that the description applies similarly to the case in which a compound of silver, platinum, palladium or copper is used as described above.

The initial suspension can be obtained, for example, by introducing the solution or dispersion of the gold compound into the dispersion of the support.

According to a specific feature of the method, the pH of the suspension thus formed is adjusted to a value of at least 8, more particularly at least 8.5 and even more particularly at least 9.

Preferably, the pH is maintained at the value of at least 8 during the formation of the suspension, during the contacting of the reducible-oxide-based compound and the gold-halide-based compound, by the concomitant introduction of a basic compound. For example, when introducing the gold compound solution or dispersion into the dispersion of the support, a basic compound is added simultaneously. The flow rate of basic compound can be adjusted in order to maintain the pH of the medium at a constant value, that is a value that is plus or minus 0.3 pH unit about the fixed value.

As a basic compound, use can be made particularly of products of the hydroxide or carbonate type. Mention can be made of alkali metal or alkaline-earth metal hydroxides and ammonia. Use can also be made of secondary, tertiary or quaternary amines. Mention can also be made of urea. The basic compound is generally used in solution form.

According to a variant of the method, use can be made of a dispersion of the support and a solution or dispersion of the gold compound, which have both been previously adjusted to a pH of at least 8, making it unnecessary to add a basic compound when they are contacted.

The contacting of the cerium-oxide-based compound and the gold-halide-based compound generally takes place at ambient temperature but it can also be carried out at higher temperature, for example at a temperature of at least 60° C.

The suspension formed in the first step of the method is generally maintained with stirring for a few minutes.

In a second step, the solid is separated from the reaction medium by any known means.

The solid thereby obtained is then washed with a basic solution. Preferably, this basic solution has a pH of at least 8, more particularly at least 9. The basic solution may be based on the same basic compounds as those mentioned above.

This washing can be carried out by any convenient method, for example by using the piston washing technique or by redispersion. In the latter case, the solid is redispersed in the basic solution and then, generally after keeping stirred, the solid is separated from the liquid medium.

The washing with the basic solution can be repeated several times if necessary. It may optionally be followed by washing with water.

On completion of the washing, the solid obtained is generally dried. The drying can be carried out by any convenient method, for example with air or by freeze drying.

The method of the invention further comprises a reducing treatment. This reducing treatment can take place either before the washing with the basic solution just described, or after this washing. In the latter case, this reducing treatment can also be carried out before or after the water washing, in the case of such a water washing, and before or after the optional drying. This treatment is carried out so that all of the gold has a degree of oxidation lower than its degree of oxidation before the treatment, the degree of oxidation before treatment generally being 3. The degree of oxidation of the gold can be determined by techniques known to a person skilled in the art, for example by the programmed temperature reduction (PTR) method or by X-ray photoelectron spectroscopy (XPS).

Various types of reducing treatment can be considered.

A chemical reduction can first be carried out by contacting the product with a reducing agent such as ferrous, citrate or stannous ions, oxalic acid, citric acid, hydrogen peroxide, hydrides like NaBH₄, hydrazine (NH₂—NH₂), formaldehyde in aqueous solution (H₂CO), phosphorus reducing agents including tetrakis(hydroxy-methyl)phosphonium chloride or NaH₂PO₂. This treatment can be carried out by placing the suspension of product in an aqueous medium containing the reducing agent or also on the product in the reaction medium after deposition of the gold.

Reduction can also be carried under ultraviolet radiation; the treatment can be carried in this case on a solution or suspension of the product or on a powder.

This treatment can be carried out before or after the washing step described above.

Furthermore, the reducing treatment can be carried out by a gas method using a reducing gas which can be selected from hydrogen, carbon monoxide or hydrocarbons, this gas being usable in any volumetric concentration. Use can be made most particularly of hydrogen diluted in argon. In the case of a reducing treatment of the latter type, it is carried out after the abovementioned washing step.

In this case, the treatment is carried out at a temperature equal to or lower than 200° C., preferably equal to or lower than 180° C. The duration of this treatment may be between 0.5 and 6 hours in particular.

On completion of the reducing treatment, it is generally unnecessary to proceed with calcination. However, such calcination is not excluded, preferably at low temperature, that is not higher than 250° C. for a duration of not more than 4 hours for example and in air. It may be advantageous to carry out such a calcination in the case of the chemical reducing treatment described above.

The method of the invention can also be implemented according to a second embodiment which will now be described.

The first step consists in depositing the gold and, if applicable, silver, platinum, palladium or copper on the compound based on reducible oxide by impregnation or by ion exchange.

The impregnation method is well known. Dry impregnation is preferably used. Dry impregnation consists in adding to the product to be impregnated, here the reducible-oxide-based support, a volume of a solution of the gold compound which is equal to the pore volume of the solid to be impregnated.

The gold compound here is of the same type as the one described above for the first embodiment.

Deposition by ion exchange is also a known method. The same type of gold compound can be used here as previously employed.

In the second step of the method, the product issuing from the preceding step is then washed with a basic solution of which the pH is at least 10, preferably at least 11. This washing can be carried out in the same way and with the same basic compounds as described for the method according to the first embodiment.

Moreover, a reducing and drying treatment can also be carried out in the second embodiment, in the same way as the one described above.

Finally, it should be noted that it is also possible, in the case of the preparation of a compound based, in addition to gold, on another metal element, to first deposit this metal element on the support, for example by impregnation, and then, subsequently, to deposit the gold by following the methods described above.

The compositions of the invention as obtained by the method described above are in the form of powders, but they may optionally be shaped into the form of granules, beads, cylinders, extrudates or honeycombs of variable dimensions. They may be used in catalyst systems comprising a wash coat based on these compositions, on a substrate of the metal or ceramic monolith type, for example. The wash coat may, for example, comprise alumina. It may be observed that the gold can also be deposited on a support previously shaped into a form of the type given above.

The compositions of the invention, as described above or obtained by the method described above, can be used more particularly, as catalysts, in methods for oxidizing carbon monoxide.

They are most particularly effective for methods of this type which are carried out at low temperatures, which means temperatures equal to or lower than 250° C. They are even effective at ambient temperature. Ambient temperature means, here and for the rest of the description unless otherwise indicated, a temperature equal to or lower than 35° C., more particularly in a range from 10° C. to 25° C. Finally, they can also be effective under high HSV conditions which, for example, may be as high as 1 500 000 cm³/g_{cata}/h.

Moreover, the compositions of the invention can be used to oxidize carbon monoxide at even lower temperatures, that is lower than 0° C., for example between −10° C. and 0° C., and for treating a gas or a medium with a very low CO content, for example of not more than 1000 ppme and for extremely high HSV values of up to 30 000 000 cm³/g_{cata}/h.

Thus, as an example of use in methods for oxidizing carbon monoxide, they can be employed in the treatment of a tobacco smoke, in the water gas shift reaction (CO+H₂O→CO₂+H₂) at a temperature lower than 100° C. in particular, or in the treatment of reforming gases at a temperature lower than 150° C., treatment of the PROX type (preferential oxidation of CO in the presence of hydrogen).

In the particular case of the treatment of tobacco smoke, the catalyst composition may be in the form of a powder. It may also undergo appropriate shaping; for example, it can be shaped into granules or flakes. In the case of a powder, the particle size distribution of the composition may be between 1 μm and 200 μm. In the case of granules, this size may be between 700 μm and 1500 μm, the size may be between 200 μm and 700 μm for beads, and between 100 μm and 1500 μm for flakes.

The catalyst composition can be incorporated by mixing or bonding with the fiber used to make the cigarette filter (for example cellulose acetate) during the production of the filter, particularly in the case of “dual filter” or “triple filter” filters. The catalyst composition can also be deposited on the inside of the paper enveloping the cable making up the filter (tipping paper) in the case of a filter of “patch filter” type. The catalyst composition can also be introduced into the cavity of a filter of “cavity filter” type.

If the catalyst composition of the invention is used in a cigarette filter, the reducing treatment can be applied to the composition after it is incorporated in the filter. The reducing treatment is then carried out by the methods described above.

The quantity of catalyst composition used is not critical. It is limited particularly by the dimensions of the filter and the pressure drop due to the presence of the composition in the filter. It is generally not more than 350 mg per cigarette, and is preferably between 20 mg and 100 mg per cigarette.

Hence the invention relates to a cigarette filter, which contains a composition as described above or obtained by the method described above.

It should be noted here that the term “cigarette” must be considered in the broad sense to cover any article intended to be smoked and based on tobacco wrapped in a tube based, for example, on paper or tobacco. Hence this term applies here also to cigars and cigarillos.

Finally, the compositions of the invention can also be used in air purification treatments in the case of an air containing at least one compound such as carbon monoxide, ethylene, aldehyde, amine, mercaptan, ozone and, in general, of the type of volatile organic compounds or atmospheric pollutants such as fatty acids, hydrocarbons, particularly aromatic hydrocarbons, and nitrogen oxides (for the oxidation of NO to NO₂) and of the type of malodorous compounds. As compounds of this type, mention can be made more particularly of ethanethiol, valeric acid and trimethylamine. This treatment is carried out by contacting the air to be treated with a composition as described previously or obtained by the method described above. The compositions of the invention are suitable for carrying out this treatment at ambient temperature.

Examples will now be provided.

In these examples, results are given for the oxidation of CO. These results were obtained by using the CO catalytic oxidation test as described below.

The catalyst compound is tested in the form of 125 to 250 μm flakes which are obtained by pelletizing, crushing and screening the catalyst compound powder. The catalyst compound is placed in the reactor on a sintered glass which acts as a physical support for the powder.

In this test, a synthetic mixture containing 1 to 10 vol % of CO, 10 vol % of CO₂, 10 vol % of O₂, 1.8 vol % of H₂O in N₂ is passed over the catalyst. The gas mixture flows continuously in a quartz reactor containing between 25 and 200 mg of catalyst compound with a flow rate of 30 L/h.

When the mass of catalyst compound is lower than 200 mg, silicon carbide SiC is added so that the sum of the masses of catalyst compound and SiC is equal to 200 mg. SiC is inert to the CO oxidation reaction and plays the role of diluent here, to ensure the homogeneity of the catalyst bed.

The CO conversion is first measured at ambient temperature (T=20° C. in the examples) and it is only when this conversion is not total at this temperature that it is increased using an oven from ambient temperature to 300° C. with a gradient of 10° C./min. The gases leaving the reactor are analyzed by infrared spectroscopy at intervals of about 10 s to measure the conversion of CO to CO₂.

If the CO conversion is not total at ambient temperature, the results are expressed as the semi-conversion temperature (T50%), temperature at which 50% of the CO present in the gas stream is converted to CO₂.

In the examples below, the catalyst compounds were evaluated for the oxidation of CO to CO₂ under the following conditions.

Conditions A: 3 vol % CO-HSV = 300 000 cm³/g_{cata}/h

| | |
|---|---|
| Gas mixture: | 3 vol % CO 10 vol % CO₂, 10 vol % |
| | O₂, 1.8 vol % H₂O in N₂ |
| Total flow rate: | 30 L/h |
| Catalyst mass: | 100 mg |
| HSV: | 300 000 cm³/g_{cata}/h |

Conditions B: 3 vol % CO-HSV = 600 000 cm³/g_{cata}/h

| | |
|---|---|
| Gas mixture: | 3 vol % CO, 10 vol % CO₂, 10 vol % |
| | O₂, 1.8 vol % H₂O in N₂ |
| Total flow rate: | 30 L/h |
| Catalyst mass: | 50 mg |
| HSV: | 600 000 cm³/g_{cata}/h |

Conditions C: 3 vol % CO-HSV = 900 000 cm³/g_{cata}/h

| | |
|---|---|
| Gas mixture: | 3 vol % CO, 10 vol % CO₂, 10 vol % |
| | O₂, 1.8 vol % H₂O in N₂ |
| Total flow rate: | 30 L/h |
| Catalyst mass: | 33 mg |
| HSV: | 900 000 cm³/g_{cata}/h |

Conditions D: 3 vol % CO-HSV = 1 200 000 cm³/g_{cata}/h

| | |
|---|---|
| Gas mixture: | 3 vol % CO, 10 vol % CO₂, 10 vol % |
| | O₂, 1.8 vol % H₂O in N₂ |
| Total flow rate: | 30 L/h |
| Catalyst mass: | 25 mg |
| HSV: | 1 200 000 cm³/g_{cata}/h |

Conditions E: 3 vol % CO-HSV = 1 500 000 cm³/g_{cata}/h

| | |
|---|---|
| Gas mixture: | 3 vol % CO, 10 vol % CO₂, 10 vol % |
| | O₂, 1.8 vol % H₂O in N₂ |
| Total flow rate: | 30 L/h |
| Catalyst mass: | 20 mg |
| HSV: | 1 500 000 cm³/g_{cata}/h |

Conditions F: 3 vol % CO-HSV = 100 000 cm³/g_{cata}/h

| | |
|---|---|
| Gas mixture: | 3 vol % CO, 10 vol % CO₂, 10 vol % |
| | O₂, 1.8 vol % H₂O in N₂ |
| Total flow rate: | 12 L/h |
| Catalyst mass: | 120 mg |
| HSV: | 150 000 cm³/g_{cata}/h |

### EXAMPLE 1

40 g of a titanium dioxide powder with a surface area of 75 m²/g were dispersed with stirring in 250 ml of water. The pH of the suspension was then adjusted to 9 by adding a solution of 1M Na₂CO₃.

Simultaneously, 0.8 g of HAuCl₄.3H₂O (Sigma-Aldrich) was dissolved in 250 ml of water.

The gold solution was then added in one hour to the titanium dioxide suspension. The pH of the suspension was maintained between 8.7 and 9.3 during the addition of the gold solution by adding a solution of 1M Na₂CO₃. The resulting suspension was maintained with stirring for 20 minutes and then filtered under vacuum.

The cake obtained was redispersed in a Na₂CO₃ solution at pH 9, the volume of which was equivalent to that of the mother liquor removed during the first filtration step. The suspension was maintained with stirring for 20 minutes. This basic washing procedure was repeated twice more. The cake obtained was finally redispersed in a volume of water equivalent to the volume of mother liquor removed during the first filtration and then filtered under vacuum.

The washed cake was freeze-dried and then reduced for 2 h at 170° C. by a gas mixture composed of 10 vol % of dihydrogen diluted in argon.

The analyses performed on the catalyst gave the results shown in Table 1 below.

### EXAMPLE 2

The catalyst was prepared according to the same protocol as the one described in Example 1, except that the titanium dioxide powder used had a surface area of 105 m²/g and that the washed cake was dried in air for 2 h at 100° C. instead of being freeze-dried before the treatment under dilute hydrogen.

The analyses performed on the catalyst gave the results shown in Table 1 below.

### COMPARATIVE EXAMPLE 3

The catalyst was prepared according to the same protocol as the one described in Example 1 except that the dried product was not treated with dilute hydrogen.

The analyses performed on the catalyst gave the results shown in Table 1 below.

### EXAMPLE 4

40 g of a titanium dioxide powder with a surface area of 105 m²/g were dispersed with stirring in 250 ml of water. The pH of the suspension was then adjusted to 9 by adding a solution of 1M NaOH.

Simultaneously, 0.8 g of HAuCl₄.3H₂O (Sigma-Aldrich) was dissolved in 250 ml of water. The solution was heated to 70° C. and its pH then adjusted to pH 9 by adding a solution of 1M NaOH.

The gold solution was then added in 30 minutes to the titanium dioxide suspension. The resulting suspension was maintained at 70° C. with stirring for one hour and then filtered under vacuum.

The cake obtained was redispersed in an NaOH solution at pH 9, the volume of which was equivalent to that of the mother liquor removed during the first filtration step. The suspension was maintained with stirring for 20 minutes. This basic washing procedure was repeated once more. The cake obtained was finally redispersed in a volume of water equivalent to the volume of mother liquor removed during the first filtration and then filtered under vacuum.

The washed cake was freeze-dried and then reduced for 2 h at 170° C. by a gas mixture composed of 10 vol % of dihydrogen diluted in argon.

The analyses performed on the catalyst gave the results shown in Table 1 below.

### EXAMPLE 5

An example is now given of the preparation of the catalyst in the form of granules.

21 g of titanium dioxide (TiO₂) granules with a specific surface of 90 m²/g were placed in a column. This column was connected via a circulation system to a reactor (1) containing 125 g of water.

Simultaneously, 0.4 g of HAuCl₄.3H₂O was dissolved in a reactor (2) containing 125 g of water. The gold solution contained in the reactor (2) was heated to 70° C. and the pH adjusted to 9 using a solution of 1M Na₂CO₃.

The solution contained in the reactor (1) was circulated through the column containing the TiO₂ granules with a flow rate of 10 mL/min. Once circulation was established between the reactor (1) and the column, the reactor (1) was heated to 70° C. and the pH adjusted to 9 using a solution of 1M Na₂CO₃.

The gold solution was introduced with stirring into the reactor (1) in 30 minutes. The pH was maintained at 9 in the reactor (1) by a solution of 1M Na₂CO₃. The solution was maintained with stirring for 1 h after adding the gold solution.

Circulation was stopped between the reactor (1) and the column.

The mother liquor was drawn off, then replaced by 250 g of water (pH adjusted to 9 with 1 M Na₂CO₃ at ambient temperature). Circulation was resumed between the reactor (1) and the column for 10 minutes. This operation was repeated twice before a final washing with 250 g of water.

The granules were separated from the wash solution and freeze-dried. They were then reduced for 2 h at 170° C. by a gas mixture composed of 10 vol % of dihydrogen diluted in argon.

The analyses performed on the catalyst gave the results shown in Table 1 below.

The two examples below concern an in situ chemical reducing treatment, that is in the reaction medium after the phase of deposition of the gold in aqueous solution.

### EXAMPLE 6

21 g of a titanium dioxide powder with a surface area of 75 m²/g was dispersed with stirring in a reactor (1) containing 125 g of water.

Simultaneously, 0.4 g of HAuCl₄.3H₂O (Sigma-Aldrich) was dissolved with stirring in a reactor (2) containing 125 g of water.

The two reactors were heated to 70° C. and, in addition, their pH was adjusted to 9 using a solution of 1M Na₂CO₃.

The gold solution was then added in 30 min in the reactor (1). During the addition of the gold solution, the pH of the reactor (1) was maintained at 9, if necessary, by adding a solution of 1M Na₂CO₃. The resulting suspension was maintained with stirring at 70° C. for 30 minutes after adding the gold solution.

0.32 g of THPC (tetrakis(hydroxymethyl)phosphonium chloride) in 80% aqueous solution (Aldrich), previously diluted in 5 ml of water, was added drop by drop to the reactor (1) in a few minutes. The quantity of THPC used corresponded to a THPC/Au molar ratio of 1.35. After this addition, the reactor (1) was maintained for 30 minutes with stirring at 70° C. After cooling, the resulting suspension was centrifuged (10 min at 45 r/min).

The cake obtained was redispersed in a Na₂CO₃ solution at pH 9, the volume of which was equivalent to that of the mother liquors removed during the first centrifugation. The suspension was maintained with stirring for 10 min before a new centrifugation. This procedure was repeated twice more. The cake obtained was finally redispersed in a volume of water equivalent to the volume of mother liquors removed during the first centrifugation.

The washed cake was dried overnight at 80° C. and calcined for 2 h at 200° C. in air.

The analyses performed on the catalyst gave the results shown in Table 1 below.

### EXAMPLE 7

21 g of titanium dioxide (TiO₂) granules with a specific surface of 90 m²/g were placed in a column. This column was connected via a circulation system to a reactor (1) containing 125 g of water.

Simultaneously, 0.4 g of HAuCl₄.3H₂O was dissolved in a reactor (2) containing 125 g of water. The gold solution contained in the reactor (2) was heated to 70° C. and the pH adjusted to 9 using a solution of 1M Na₂CO₃.

The solution contained in the reactor (1) was circulated through the column containing the TiO₂ granules at a flow rate of 10 mL/min. Once circulation was established between the reactor (1) and the column, the reactor (1) was heated to 70° C. and the pH adjusted to 9 using a solution of 1M Na₂CO₃.

The gold solution was introduced with stirring into the reactor (1) in 30 minutes. The pH was maintained at 9 in the reactor (1) by a solution of 1M Na₂CO₃. The solution was maintained with stirring for 1 h after the addition of the gold solution.

0.32 g of THPC (tetrakis(hydroxymethyl)-phosphonium chloride) in 80% aqueous solution (Aldrich), previously diluted in 5 ml of water, was added drop by drop to the reactor (1) in a few minutes. The quantity of THPC added corresponded to a THPC/Au molar ratio of 1.35.

After this addition, the reactor (1) was maintained for 30 minutes with stirring at 70° C. and circulation was then stopped between the reactor (1) and the column.

The mother liquor was drawn off and replaced by 250 g of water (pH adjusted to 9 with 1M Na₂CO₃ at ambient temperature). Circulation was resumed between the reactor (1) and the column for 10 minutes. This operation was repeated twice before a final washing with 250 g of water.

The granules were separated from the wash solution and dried at 80° C. overnight and finally calcined in air at 200° C. for 2 h.

The analyses performed on the catalyst gave the results shown in Table 1 below.

### EXAMPLE 8

40 g of a ferrous oxide (Fe₂O₃) powder with a surface area of 225 m²/g was dispersed with stirring in 250 ml of water. The pH of the suspension was then adjusted to 9 by adding a solution of 1M Na₂CO₃.

Simultaneously, 0.8 g of HAuCl₄.3H₂O (Sigma-Aldrich) was dissolved in 250 ml of water.

The gold solution was then added in one hour to the ferrous oxide suspension. The pH of the suspension was maintained at 9 during the addition of the gold solution by adding a solution of 1M Na₂CO₃. The resulting suspension was maintained with stirring for 20 minutes and then filtered under vacuum.

The cake obtained was redispersed in a Na₂CO₃ solution at pH 9, the volume of which was equivalent to that of the mother liquors removed during the first filtration step. The suspension was maintained with stirring for 20 minutes. This basic washing procedure was repeated twice more. The cake obtained was finally redispersed in a volume of water equivalent to the volume of mother liquors removed in the first filtration and then filtered under vacuum.

The washed cake was freeze-dried and reduced for 2 h at 170° C. by a gas mixture composed of 10 vol % of dihydrogen diluted in argon.

The analyses performed on the catalyst gave the results shown in Table 1 below.

TABLE 1

| | Au particle size | Au content | Cl/Au |
|---|---|---|---|
| Example | (nm) | (%) | (molar) |
| 1 | <3 | 0.65 | 0.034 |
| 2 | <3 | 0.64 | 0.034 |
| 3 | <3 | 0.65 | 0.034 |
| 4 | <3 | 0.65 | 0.034 |
| 5 | <3 | 0.65 | 0.008 |
| 6 | <3 | 1.00 | 0.006 |
| 7 | <3 | 0.80 | 0.007 |
| 8 | <3 | 0.80 | 0.007 |

Table 2 below gives the results obtained with the catalysts of the examples for the conversion of CO (3% vol % % of CO).

TABLE 2

| | Conditions | | | | | |
|---|---|---|---|---|---|---|
| Example | A | B | C | D | E | F |
| 1 | 100% | 100% | 100% | 100% | 100% | — |
| | at Ta | at Ta | at Ta | at Ta | at Ta | |
| 2 | 100% | — | — | — | — | — |
| | at Ta | | | | | |
| 3 | 50% at | — | — | — | — | — |
| | 42° C. | | | | | |
| 4 | 100% | 100% | 100% | 50% at | — | — |
| | at Ta | at Ta | at Ta | 44° C. | | |
| 5 | — | — | — | 100% | 100% | — |
| | | | | at Ta | at Ta | |
| 6 | — | — | — | 100% | | — |
| | | | | at Ta | | |
| 7 | — | — | — | — | 100% | — |
| | | | | | at Ta | |
| 8 | — | — | — | — | — | 40% at |
| | | | | | | 46° C. |

Ta: ambient temperature = 20° C.

It may be observed that the catalyst in example 3 only converted 50% of the CO, and at a temperature above 35° C., whereas the catalyst in example 1 oxidized the CO to CO₂ totally at ambient temperature for HSV values ranging at least up to 1 500 000 cm³/g_{cata}/h.

The results are now given for the oxidation of low CO contents to CO₂ using the test described above. The oxidation reaction took place at low temperature, −10° C., under the following conditions:

Conditions G: 50 vpm CO-HSV = 900 000 cm³/g_{cata}/h

| | |
|---|---|
| Gas mixture: | 50 vpm CO, 20 vol % O₂ in N₂ |
| Total flow rate: | 30 L/h |
| Catalyst mass: | 33 mg |
| HSV: | 900 000 cm³/g_{cata}/h |

Conditions H: 50 vpm CO-HSV = 3 000 000 cm³/g_{cata}/h

| | |
|---|---|
| Gas mixture: | 50 vpm CO, 20 vol % O₂ in N₂ |
| Total flow rate: | 30 L/h |
| Catalyst mass: | 10 mg |
| HSV: | 3 000 000 cm³/g_{cata}/h |

Conditions I: 50 vpm CO-HSV = 6 000 000 cm³/g_{cata}/h

| | |
|---|---|
| Gas mixture: | 50 vpm CO, 20 vol % O₂ in N₂ |
| Total flow rate: | 30 L/h |
| Catalyst mass: | 5 mg |
| HSV: | 6 000 000 cm³/g_{cata}/h |

Table 3 below gives the results obtained with the catalyst of example 1 for the conversion of 50 vpm CO at low temperature.

TABLE 3

| | Conditions | | |
|---|---|---|---|
| Example 1 | G | H | I |
| T = 10° C. | Conv(CO) = 100% | Conv(CO) = 60% | Conv(CO) = 35% |
| T = 0° C. | Conv(CO) = 100% | Conv(CO) = 90% | — |
| T = 10° C. | Conv(CO) = 100% | Conv(CO) = | Conv(CO) = 90% |
| | | 100% | |

The results are now given for the oxidation of low CO contents to CO₂ at very high HSV values using the following test.

Two 30 L gas bags were connected respectively to the inlet and outlet of a pump via a rubber tube with an internal diameter of 8 mm. The catalyst compound in the form of flakes measuring 125 to 250 μm and obtained by pelletizing, crushing and screening the catalyst compound powder was placed in the rubber tube between the outlet of the pump and the gas bag. The catalyst compound was immobilized by two rock wool plugs. While the gas bag connected to the pump outlet was empty, an atmosphere containing 100 vpm of CO in air was created in the bag connected to its inlet. At t=O, the pump was started with a flow rate of 50 L/min and the content of the gas bag connected to the inlet was transferred via the catalyst bed into the initially empty gas bag. The CO content of the gas bag was then measured using a Draeger CO reagent tube. This test was performed at ambient temperature under the following conditions:

Conditions J: 100 vpm CO-HSV = 10 000 000 cm³/g_{cata}/h

| | |
|---|---|
| Gas mixture: | 100 vpm CO, 20 vol % O₂ in N₂ |
| Total flow rate: | 50 L/min |
| Catalyst mass: | 300 mg |
| HSV: | 10 000 000 cc/g_{cata}/h |

Conditions K: 100 vpm CO-HSV = 15 000 000 cm³/g_{cata}/h

| | |
|---|---|
| Gas mixture: | 100 vpm CO, 20 vol % O₂ in N₂ |
| Total flow rate: | 50 L/min |
| Catalyst mass: | 200 mg |
| HSV: | 15 000 000 cc/g_{cata}/h |

Conditions L: 100 vpm CO-HSV = 30 000 000 cm³/g_{cata}/h

| | |
|---|---|
| Gas mixture: | 100 vpm CO, 20 vol % O₂ in N₂ |
| Total flow rate: | 50 L/min |
| Catalyst mass: | 100 mg |
| HSV: | 30 000 000 cc/g_{cata}/h |

Table 4 below gives the results obtained with the catalyst of example 1 for the conversion of 100 vpm CO at ambient temperature.

TABLE 4

Conditions

| Example 1 | J | K | L |
|---|---|---|---|
| T = 28° C. | Conv(CO) = | Conv(CO) = | Conv(CO) = |
| | 35 ± 5% | 50 ± 5% | 65 ± 5% |

The results in Tables 3 and 4 show that the catalyst of the invention is capable of oxidizing CO to CO₂ at very low CO contents and very high HSV values.

The next example concerns the conversion of ozone (O₃) to oxygen (O₂) by a decomposition reaction. This result was obtained by using the catalyst test described below.

In this test, a closed polymer chamber with a volume of 5.3 L is equipped with several orifices for introducing ozone, for introducing catalyst and for sampling the gas phase.

An ozone generator is used, regulated to supply a gas stream containing 125 g/m³ of ozone in air. A 100 ml gas container is filled with this gas stream and then 17 ml are withdrawn from this gas container using a gas syringe, the contents of which are then injected into the closed chamber to create an atmosphere containing 200 vmp of ozone in air.

Subsequently, 200 mg of catalyst compound in powder form are introduced into the chamber using a device avoiding any contact with the atmosphere outside the chamber. The time origin is determined by the introduction of the catalyst into the chamber. The gas phase is homogenized using a recirculating pump with a delivery of 13.5 L/min.

The disappearance of the ozone present in the chamber is monitored over time using Draeger reagent tubes for ozone.

The conversion in molecules (M) of ozone to be oxidized is calculated as follows using the concentrations determined with the Draeger reagent tubes:
Conv(M)=[conc_{M}(t)−conc_{M}(t=0)]/conc_{M}(t=0)

### EXAMPLE 9

The catalyst of example 1 is used in the test which was described above.

Table 5 below gives the results obtained at ambient temperature for the conversion of 200 vpm of ozone.

TABLE 5

| Time (min) | O₃ Conv. |
|---|---|
| 0 | 0 |
| 5 | 80 |
| 10 | 100 |

These data show that 200 vpm of ozone is decomposed to oxygen in less than 10 min at ambient temperature.

### EXAMPLE 10

An example is now given of the preparation of a catalyst in the form of granules containing silver in addition to the gold.

40 g of titanium dioxide (TiO₂) granules with a specific surface of 90 m²/g were impregnated by 25.8 ml of an aqueous solution containing 6.7×10⁻² M of AgNO₃. The paste was then dried in an oven overnight at 120° C. and calcined in air at 500° C. for 2 h.

The gold was then deposited on 21 g of granules thus obtained, according to the procedure in example 5.

The analyses performed on the catalyst gave the results given in Table 6 below.

TABLE 6

| | Au | | | | |
|---|---|---|---|---|---|
| | particle | Au | Ag | | |
| | Size | content | content | Cl/Au | Ag/Au |
| Example | (nm) | (%) | (%) | (molar) | (molar) |
| 10 | <3 | 0.65 | 0.4 | 0.008 | 1.13 |

Table 7 below gives the results obtained with the catalysts of the examples for the conversion of 3 vol % of CO.

TABLE 7

Conditions

| Example | D | E |
|---|---|---|
| 5 | 100% at Ta | 100% at Ta |
| | max conv at t = 90 s | max conv at t = 120 s |
| 10 | 100% at Ta | 100% at Ta |
| | max conv at t = 0 s | max conv at t = 0 s |

Ta: Ambient temperature=20° C.

It can be seen that the catalyst in example 10 displays the property of reaching its maximum CO conversion level more rapidly than that of example 5.

The examples below concern the oxidation of various volatile organic compounds (VOC) such as acetaldehyde (CH₃CHO), methanol (CH₃OH), ethanethiol (CH₃CH₂SH), valeric acid (CH₃(CH₂)₃CO₂H) and trimethylamine ((CH₃)₃N). These results were obtained by using the catalytic oxidation test described below.

In this test, a closed polymer chamber with a volume of 5.3 L is equipped with several orifices for introducing the molecule to be oxidized, for introducing the catalyst and for sampling the gas phase.

Initially, a volume of liquid molecule is introduced using a syringe into the closed chamber. The injected volumes are 2.5, 2, 3.5, 5 and 6 μL respectively for acetaldehyde, methanol, ethanethiol, valeric acid and trimethylamine (in 50% aqueous solution). At ambient temperature (T=20 to 30° C.), all the injected liquid is vaporized in the chamber to create an atmosphere consisting of 200 vpm of molecule to be oxidized in air.

Subsequently, 200 mg of catalyst compound in powder form is introduced into the chamber using a device avoiding any contact with the atmosphere outside the chamber. The time origin is determined by the introduction of the catalyst into the chamber. The gas phase is homogenized using a recirculating pump with a delivery of 13.5 L/min.

To monitor the oxidation reaction, the gas phase of the chamber was sampled through a septum and analyzed by gas chromatography. H₂O, CO, CO₂, CH₃CHO, CH₃OH and CH₃CH₂SH were analyzed on a Hewlett Packard Micro GC HP M200 chromatograph using the sampling device with which this analyzer was equipped. Valeric acid (CH₃(CH₂)₃CO₂H) and trimethylamine ((CH₃)₃N) were analyzed on a Varian 3200 chromatograph using a syringe for sampling the gas phase of the closed chamber. The gas phase was analyzed before introduction of the catalyst and then after introduction at regular intervals ranging from a few minutes to a few hours depending on the trials.

The conversion of molecule to be oxidized (M) was calculated as follows using the chromatogram areas:
Conv(M)=[area_{M}(t)−area_{M}(t=0)]/area_{M}(t=0)

For each molecule to be oxidized, a blank test without catalyst was performed under the same conditions, for which no change in the concentration of molecule to be oxidized was observed over time.

### EXAMPLE 11

The catalyst of example 1 was used in the test which was described above.

Table 8 below gives the results obtained at ambient temperature for the conversion of 200 vpm of acetaldehyde.

TABLE 8

| Time (min) | CH₃CHO Conv. |
|---|---|
| 0 | 0 |
| 8 | 65 |
| 23 | 86 |
| 38 | 95 |
| 53 | 100 |

These data show that 200 vpm of acetaldehyde was converted completely in less than 1 h of reaction.

Chromatographic analysis confirmed that the quantities of CO₂ and H₂O produced clearly corresponded to a total oxidation reaction leading to the removal of the acetaldehyde according to the equation:
CH₃CHO+5/2O₂→2CO₂+2H₂O

### EXAMPLE 12

The catalyst of example 1 was used in the test which was described above.

Table 9 below gives the results obtained at ambient temperature for the conversion of 200 vpm of methanol.

TABLE 9

| Time (min) | CH₃OH Conv. |
|---|---|
| 0 | 0 |
| 11 | 38 |
| 36 | 48 |
| 74 | 55 |
| 182 | 67 |
| 1157 | 91 |

These data show that 200 vpm of methanol was converted to over 90% in 20 h of reaction. Chromatographic analysis confirmed that the quantities of CO₂ and H₂O produced clearly corresponded to a total oxidation reaction leading to the removal of the methanol according to the equation:
CH₃OH+3/2O₂→CO₂+2H₂O

### EXAMPLE 13

The catalyst of example 1 was used in the test which was described above.

Table 10 below gives the results obtained at ambient temperature for the conversion of 200 vpm of ethanethiol.

TABLE 10

| Time (min) | CH₃CH₂SH Conv. |
|---|---|
| 0 | 0 |
| 10 | 62 |
| 25 | 75 |
| 55 | 90 |
| 85 | 94 |
| 115 | 96 |

These data show that 200 vpm of ethanethiol was converted to over 70% after 1 h of reaction.

The analysis of the gas phase with a Draeger sulfur dioxide SO₂ tube at t=50 min showed that over 100 vpm of SO₂ was present in the chamber. The changes in CO₂ and H₂O concentrations and the presence of SO₂ indicated that the disappearance of the ethanethiol could be attributed to its partial oxidation.

### EXAMPLE 14

The catalyst of example 1 was used in the test which was described above.

Table 11 below gives the results obtained at ambient temperature for the conversion of valeric acid.

TABLE 11

| Injection 200 vpm | Time | Concentration |
|---|---|---|
| CH₃(CH₂)₃CO₂H | (min) | CH₃(CH₂)₃CO₂H (vpm) |
| 1^{st} injection | 0 | 200 |
| | 11 | 13 |
| | 27 | 0 |
| 2^{nd} injection | 54 | 0 |
| | 64 | 44 |
| | 80 | 20 |
| | 96 | 3 |

These data show that each of the injections of 200 vpm of valeric acid was converted in less than 60 minutes.

The analysis of the gas phase showed that overall 400 vpm of valeric acid were converted and that 200 vpm of CO₂ and 1000 vpm of H₂O were formed. The changes in CO₂, H₂O and valeric acid concentrations indicated that the disappearance of the valeric acid could be attributed to its partial oxidation.

### EXAMPLE 15

The catalyst of example 1 was used in the test which was described above.

Table 12 below gives the results obtained at ambient temperature for the conversion of 200 vpm of trimethylamine.

TABLE 12

| Time (min) | (CH₃)₃N Conv. |
|---|---|
| 0 | 0 |
| 6 | 74 |
| 21 | 82 |
| 48 | 83 |
| 90 | 90 |

These data show that 200 vpm of trimethylamine were converted to over 80% after 30 min of reaction.

The analysis of the gas phase showed that 50 vpm of CO₂ and 1000 vpm of H₂O were also formed. The changes in CO₂, H₂O and trimethylamine concentrations indicated that the disappearance of the trimethylamine could be attributed to its partial oxidation.

1-18. (canceled)

19. A gold-based composition on a support based on at least one reducible oxide, having a halogen content expressed by the halogen/gold molar ratio equal to or lower than 0.05, the gold being present in the form of particles equal to or lower than 10 nm in size, and having undergone a reducing treatment, to the exclusion of compositions with supports in which the only reducible oxide or oxides is/are cerium oxide, cerium oxide in combination with zirconium oxide, cerium oxide in combination with praseodymium oxide, cerium oxide in combination with titanium dioxide or stannous oxide in a Ti/Ce or Sn/Ce atomic proportion lower than 50%.

20. The composition as claimed in claim 19, wherein the support is based on at least one oxide which is titanium dioxide, manganese dioxide, ferric oxide or stannous oxide.

21. The composition as claimed in claim 19, wherein the halogen content is equal to or lower than 0.04, optionally equal to or lower than 0.025.

22. The composition as claimed in claim 19, wherein the gold is present in the form of particles equal to or lower than 3 nm in size.

23. The composition as claimed in claim 19, wherein the halogen is chlorine.

24. The composition as claimed in claim 19, wherein the gold content is equal to or lower than 5%, optionally equal to or lower than 1%.

25. The composition as claimed in claim 19, furthermore comprising at least one other metal element which is silver, platinum, palladium or copper.

26. The composition as claimed in claim 25, wherein the other metal element is present in a quantity equal to or lower than 400%, optionally between 5% and 50%, compared with the gold.

27. A method for preparing a composition as defined in claim 19, comprising the following steps:
a) contacting a compound based on at least one reducible oxide with a gold-halide-based compound and, optionally, a compound based on silver, platinum, palladium or copper,
b) forming a suspension of these compounds in a reaction medium, the pH of the medium thereby formed being fixed at a value of at least 8;
c) separating the solid from the reaction medium obtained in step b);
d) washing the solid with a basic solution; and
e) carrying out a reducing treatment before or after step d).

28. The method as claimed in claim 27, wherein in step b), the pH of the medium formed is maintained at the value of at least 8 during the formation of the suspension of the compound based on at least one reducible oxide and of the gold-halide-based compound and, optionally, of the compound based on silver, platinum, palladium or copper, by the addition of a basic compound.

29. The method as claimed in claim 27, wherein in step d) the solid obtained is washed with a basic solution with a pH of at least 8, optionally of at least 9.

30. A method for preparing a composition as claimed in claim 19 wherein it comprises the following steps:
a) depositing gold and, optionally, silver, platinum, palladium or copper on a compound based on at least one reducible oxide by impregnation or by ion exchange in order to obtain a solid;
b) washing the solid obtained in step a) with a basic solution with a pH of at least 10; and
c) carrying out a reducing treatment before or after the step b).

31. The method as claimed in claim 30, wherein step c) is performed with a reducing gas at a temperature not higher than 200° C., optionally not higher than 180° C.

32. The method as claimed in claim 27, wherein step e) is performed with a reducing gas at a temperature not higher than 200° C., optionally not higher than 180° C.

33. The method as claimed in 27, wherein the solid obtained after the reducing treatment e) is further subjected to a calcination at a temperature not higher than 250° C.

34. The method as claimed in 27, wherein the solid obtained after the reducing treatment c) is further subjected to a calcination at a temperature not higher than 250° C.

35. A method for purifying air, said air containing carbon monoxide, ethylene, aldehyde, amine, mercaptan, ozone, a volatile organic compounds or an atmospheric pollutant or a malodorous compound, comprising the steps of contacting said air with a composition as claimed in claim 19.

36. A cigarette filter, comprising a composition as claimed in claim 19.
